(19) United States
(12) Patent Application Publication
(10) Pub. No.: US 2026/0066748 A1
(43) Pub. Date: Mar. 5, 2026

(54) TRANSFORMER FOR EXTERNALLY EXCITED SYNCHRONOUS MACHINES: INTEGRATION VIA BEARINGS

(71) Applicant: Schaeffler Technologies AG & Co. KG, Herzogenaurach (DE)

(72) Inventors: Martin Kunkemoeller, Sasbach (DE); Thomas Hurle, Bühlertal (DE); Jan Michel Wassermann, München (DE); Bao Ngoc An, Karlsruhe (DE); Richard Bernauer, Weilheim (DE); Christian Hartmann, Emskirchen (DE)

(21) Appl. No.: 19/124,752

(22) PCT Filed: Oct. 6, 2023
(86) PCT No.: PCT/DE2023/100740

§ 371 Date: Apr. 25, 2025

(30) Foreign Application Priority Data
Oct. 27, 2022 (DE) 102022128542.1

(51) Int. Cl. H02K 11/33; H01F 38/18; H02K 5/173; H02K 5/20; H02K 11/042

(52) U.S. Cl. CPC H02K 11/33; H01F 38/18; H02K 5/173; H02K 5/203; H02K 11/042

(57) ABSTRACT

A contactless energy transmission device for a rotor of an electric machine is disclosed. The device includes a housing part, which can be coupled in a rotationally rigid manner to a housing of the electric machine, and an inductive transformer which has an energizable primary coil and a secondary coil that is arranged at a distance thereto and can be electrically coupled to a winding of the rotor a roller bearing, by means of which a rotor shaft is rotatably mounted relative to the housing part, wherein the primary coil is positioned on the housing part in a rotationally rigid manner relative thereto, and the roller bearing is arranged within the housing part such that the primary coil and the roller bearing are arranged coaxially, and the secondary coil is arranged within a transformer housing.

### CROSS-REFERENCE TO RELATED APPLICATION

The present application is the U.S. National Phase of PCT Patent Application Number PCT/DE2023/100740, filed on Oct. 6, 2023, which claims priority to German Patent Application Number 10 2022 128 542.1, filed Oct. 27, 2022, the entire disclosures of which are incorporated by reference herein.

### TECHNICAL FIELD

The present disclosure relates to a contactless energy transmission device for a rotor of an electric machine, in particular an externally excited synchronous machine within a powertrain of a motor vehicle.

### BACKGROUND

Electric machines are increasingly being used to drive motor vehicles to create alternatives to internal combustion engines that require fossil fuels. Significant efforts have already been made to improve the suitability of electric drives for everyday use and also to be able to offer users the driving comfort which they are accustomed to.

A detailed description of an electric drive can be found in an article in the German automotive magazine ATZ, volume 113, 05/2011, pages 360-365 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for an axle of a vehicle, which includes an electric motor. Such drive units are also referred to as e-axles or electrically operable powertrains.

In addition to purely electrically operated powertrains, hybrid powertrains are also known. Such powertrains of a hybrid vehicle usually comprise a combination of an internal combustion engine and an electric motor, and enable, for example in urban areas, a purely electric mode of operation while at the same time permitting both sufficient range and availability, in particular when driving cross-country. In addition, drive can also be provided by the internal combustion engine and the electric motor at the same time in certain operating situations. Depending on the embodiment, both purely electric and hybrid powertrains have a transmission, which is used, for example, to adjust the speed and power ranges.

When developing the electric machines intended for e-axles or hybrid modules, there is a continuing need to increase their power density and efficiency while reducing manufacturing costs, since the cost and weight of the vehicle will be largely determined by the battery size. In this context, it is also known to design the electrical machines as externally excited synchronous machines. The electrical power to excite the rotor windings must be transferred to the rotor of an externally excited synchronous machine. For traction machines, a contact-based transformer is usually used for this purpose. When these windings are energized, a magnetic field is created which, in combination with the magnetic field of the stator, generates a torque. The strength of the rotor field can be adjusted by the strength of the current supply. In this way, the machine behavior can always be adapted to the respective driving situation in an efficient manner.

The disadvantages of such a contact-based transformer are mechanical and electrical losses in the contact between stationary and rotating components. Further disadvantages are the wear of the components rubbing against each other and the resulting contamination through abrasion as well as the comparatively large installation space required.

As an alternative to such contact-based transformers, contactless, inductive transformers are also known. An inductive transformer is usually a rotationally symmetrical transformer with an air gap consisting of a primary and a secondary winding. As a rule, an inductive transformer also has a core made of ferrite, for example. Such a core can be made of one or more parts.

For example, all parts of the core can be attached to the stationary machine side of an electric machine, wherein the secondary-side winding rotates within the core. Alternatively, core parts can be attached to the rotating part of the machine. In this case, the primary and secondary core parts are separated by an air gap. This must then be large enough so that the core parts do not touch each other, taking into account all tolerances and operating conditions. For this purpose, the rotating transformer parts are often provided with a binding or joined to another component in order to support them at a fixed speed. An example of such a design variant can be found in DE 10 2017 214 776 A1 or in DE201210201826 A1.

### SUMMARY

The object of the disclosure is now to provide a contactless energy transmission device for a rotor of an electric machine, in particular an externally excited synchronous machine within a powertrain of a motor vehicle, which also has a compact design and a high level of operational reliability when a high level of electrical power is to be transmitted.

This object is achieved by the measures described in the independent claims. Advantageous embodiments can be found in the dependent claims.

The primary coil of the energy transmission device—in short the transformer—of an electric machine, comprising a ferrite core and windings, is arranged coaxially around a roller bearing, hereinafter also called rotor bearing, comprising a bearing outer ring. The bearing outer ring is inserted into a housing part, on the outer diameter of which the primary coil is placed. The housing part is an integral part of a bearing plate or is connected thereto. This arrangement can be implemented on both the side of the electric machine facing the transmission and the side facing away from the transmission. The housing part is preferably designed as a substantially rotationally symmetrical body, which can be divided into two cylinder ring sections. The second cylinder ring section extends radially outward from an outer lateral surface of a first cylinder ring section.

The coaxial arrangement of rotor bearing and transformer makes it possible to save axial installation space and keep the external dimensions of the machine compact. In addition, a design with a radial air gap and a flat but axially long coil cross section can be selected for the electric machine, which is electromagnetically advantageous.

The primary coil is thermally connected to the housing part on which it is arranged, so that heat from the primary coil can be dissipated via the housing part, in particular to a machine housing of the electric machine, and thermal overload can be avoided.

An inverter electronics for supplying the primary side is integrated between the housing part and the primary coil and is thermally connected to the housing part, which is designed in particular as a bearing plate. In this way, heat from the inverter electronics can be dissipated, particularly to the machine housing, and thermal overload can be avoided.

The arrangement of the primary coil, inverter electronics, and housing part represents a self-contained, manufacturable, and testable unit, which increases the quality of the machine and reduces waste. In other words, the primary coil, the inverter electronics, and the housing part form a modular structural unit.

In one embodiment, the housing part, which is in particular designed as a bearing plate, has integrated therein at least one channel, which extends radially or tangentially at least in sections, for guiding a cooling liquid, thereby improving heat dissipation. The channel is arranged in particular as a through-opening into the interior of the housing part. The heat transfer thus occurs from the inverter electronics via the housing part to the cooling medium. The inverter electronics are arranged on an axial surface of the housing part. The axial surface preferably faces the electric machine.

In a further embodiment, at least one groove is formed in the bearing plate, which groove is covered by the inverter electronics and thus forms a channel for guiding a cooling liquid. Elements such as ribs or pins can be formed within the groove to increase the surface area facing the cooling medium. This can further improve heat dissipation from the primary coil and inverter electronics.

In one embodiment, the primary coil and the inverter electronics are cast on the housing part with an epoxy compound or overmolded with plastic, which improves protection against environmental influences, thermal coupling, and electrical insulation of the components.

The secondary coil comprises a ferrite core and a winding and is inserted into a substantially pot-shaped housing, which is also referred to as the transformer housing. In other words, the transformer housing is designed as a hollow cylinder, which preferably has a connection at a distal end for mounting, in particular, on the rotor, in particular a rotor shaft. The rectifier electronics are also located inside the housing and are thermally connected to the housing. The housing is preferably mounted in the axial direction to the rotor housing or rotor body. The housing has openings for the passage of electrical cables. The housing can be made of aluminum or glass fiber-reinforced plastic, for example. The housing can consist of multiple parts. Alternatively, the housing may be integrally connected to the rotor housing or rotor body or formed from any of the foregoing.

This arrangement ensures that the rectifier electronics and secondary coil are firmly supported at high speeds and thermally coupled to the rotor housing so that heat can be dissipated. In addition, heat can be dissipated convectively via the radial outer surfaces of the transformer housing.

The secondary-side arrangement comprises the secondary coil, rectifier electronics, and transformer housing. It represents a self-contained, manufacturable, and testable unit, which increases the quality of the machine and reduces waste. In other words, the secondary coil, the rectifier electronics, and the transformer housing form a modular structural unit.

In one embodiment, the outer surfaces of the transformer housing are provided with tangential ribs, which improves speed stability and convective heat dissipation.

In one embodiment, the rectifier electronics and secondary coil are cast in the transformer housing with an epoxy compound or overmolded with plastic, which improves protection against environmental influences, thermal coupling, and electrical insulation of the components.

In a further embodiment, at least one cavity between the rotor housing and the transformer housing forms a channel for guiding a cooling medium, thereby improving the heat dissipation from the secondary-side arrangement.

The individual elements of the claimed subject matter of the disclosure are explained below.

A rotor is the rotating (spinning) part of an electric machine. The rotor comprises in particular a rotor shaft. The rotor shaft can be hollow, which on the one hand results in weight savings and on the other hand allows the supply of lubricant or coolant to the rotor body. Preferably, the hollow shaft of the contactless energy transmission device is a rotor shaft of a rotor of an electric machine that is hollow at least in sections.

The electric machine can in particular be designed as a rotary machine. The rotary machine can in particular be configured as a radial flow machine. A radial flow machine is characterized by the fact that the magnetic field lines in the air gap formed between the rotor and stator extend in a radial direction. The gap between the rotor and the stator is referred to as the air gap. In a radial flow machine, this is an annular gap with a radial width that corresponds to the distance between the rotor body and the stator body.

The electric machine is intended in particular for use within a powertrain of a hybrid or fully electrically driven motor vehicle. In particular, the electric machine is dimensioned such that vehicle speeds of more than 50 km/h, preferably more than 80 km/h, and in particular more than 100 km/h can be achieved. The electric motor particularly preferably has an output of more than 50 kW, preferably more than 80 kW, and in particular more than 150 kW. Furthermore, it is preferred that the electric machine provides speeds greater than 8,000 rpm, particularly preferably greater than 12,000 rpm, very particularly preferably greater than 1,500 rpm.

For the purposes of this application, motor vehicles are land vehicles that are moved by machine power without being bound to railroad tracks. A motor vehicle can be selected, for example, from the group of passenger cars, trucks, small motorcycles, light motor vehicles, motorcycles, motor buses/coaches or tractors.

The inductive transformer is configured so that electrical powers preferably greater than 1 kW and particularly preferably greater than 2 kW can be transmitted at least for a short time without electrically or thermally overloading the transformer. Most preferably, the inductive transformer is configured to transmit electrical power between 0.5 kW-10 kW, preferably between 1 kW-5 kW, particularly preferably between 2 kW-4 kW.

The windings of the transformer are made of an electrically conductive but non-ferromagnetic material, such as copper or aluminum, and are electrically insulated from each other. Preferably, the windings are aligned tangentially around the hollow shaft, so that a cylindrical ring-like winding body with a diameter and a longitudinal extension in the axial direction is obtained. Most preferably, the windings are wound around and/or in a core made of a ferromagnetic material.

The windings can be formed from one or more electrical conductors with a circular cross-section. It is also conceivable that the electrical conductors forming the winding have a cross-sectional shape that deviates from the circular shape, in particular a rectangular shape. Particularly preferably, the windings can be formed from insulated copper foils, which can be wound around each other in a similar way to a toilet paper roll.

According to an advantageous further development of the disclosure, the primary winding can have a higher number of turns than the secondary winding. This means that, when transferring electrical energy between the primary winding and the secondary winding, a voltage conversion from the comparatively high battery voltage to the lower rotor voltage can be realized.

In this context, it is further preferred that an electrical voltage of 40-1500 V, preferably 100-1000 V, most preferably 300-850 V is applied to the primary winding. Furthermore, in this context, it is preferable that a voltage of 70-500 V is applied to the secondary winding.

The primary core and/or the secondary core are/is made of a ferromagnetic material, preferably a ferrite material. The primary core and/or secondary core can be designed in several parts. The respective core parts are preferably substantially rotationally symmetrical, but can contain elements and recesses for fixing or implementing additional components.

Particularly preferably, the primary core and/or the secondary core each have a ring-like spatial shape. Most preferably, the primary core and/or the secondary core have/have a U-shaped cross-sectional contour with a circumferential groove. Preferably, the grooves of the U-shaped cross-sectional contours of the primary core and secondary core are directed towards each other. It is also particularly preferred that the primary winding runs in the groove of the primary core and/or the secondary winding runs in the groove of the secondary core.

Both the disclosure and the technical field are explained in more detail below with reference to the figures. It should be noted that the disclosure is not intended to be limited by the exemplary embodiments shown. In particular, unless explicitly stated otherwise, it is also possible to extract sub-aspects of the subject matter explained in the figures and to combine them with other components and knowledge from the present description and/or figures. In particular, it should be noted that the figures and in particular the proportions shown are only schematic in nature. Identical reference symbols indicate the same objects, such that, where applicable, explanations from other figures can also be used. Terms such as “radial,” “axial” or similar refer to the rotational axis of the electric machine, unless a different reference is explicitly used. Furthermore, in order to improve the readability of the figures, only individual or a few identical elements of a reference symbol are provided in some cases.

### BRIEF DESCRIPTION OF THE DRAWINGS

In the figures:

FIG. 1 shows an electric machine with a contactless energy transmission device in a schematic axial sectional view in a first embodiment,

FIG. 2 shows an electric machine with a contactless energy transmission device in a schematic axial sectional view in a second embodiment,

FIG. 3 shows an electric machine with a contactless energy transmission device in a schematic axial sectional view in a third embodiment,

FIG. 4 shows an electric machine with a contactless energy transmission device in a schematic axial sectional view in a fourth embodiment.

### DESCRIPTION OF PREFERRED EXEMPLARY EMBODIMENTS

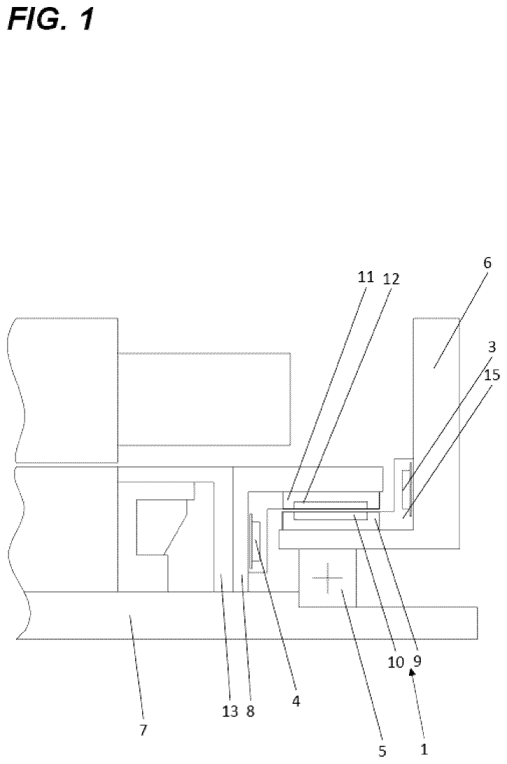

FIG. 1 shows an electric machine with a contactless energy transmission device in a schematic axial sectional view in a first embodiment. The electric machine is an externally excited synchronous machine. The rotor 110 comprises a rotor shaft 7 designed as a hollow shaft and a rotor body in which windings are arranged to form a magnetic field. The rotor body is closed in the axial direction by a rotor housing 13. The rotor shaft 7 is rotatably arranged via a roller bearing 7 in a housing part 6 designed as a bearing plate. The housing part is designed as a rotating body which has a first cylinder ring section with an inner lateral surface and an outer lateral surface. The roller bearing is arranged with its outer ring on the inner lateral surface. A primary coil 1 of an inductive transformer of an energy transmission device is arranged on the outer lateral surface. The primary coil 1 and the roller bearing 5 overlap in the axial direction, at least in sections. Furthermore, the roller bearing 5 and the primary coil 1 are arranged coaxially. The primary coil 1 comprises a ferrite core 9 and a winding 10. A second cylinder ring section of the housing part 6 extends in the radial direction starting from the outer lateral surface of the first cylinder ring section. Thus, the first cylinder ring section and the second cylinder ring section form an L-shaped cross section, wherein one leg is aligned parallel to a rotation axis of the rotor and the other leg extends radially outward. An inverter electronics 3 is arranged on a first axial surface of the second cylinder ring section. The first axial surface of the second cylinder ring section faces the rotor 110. In the embodiment shown, the primary coil 1 and the inverter electronics 3 are encapsulated with an epoxy compound to protect against environmental influences and to improve the thermal coupling and electrical insulation of the components. The primary coil 1, the inverter electronics 3 and the housing part 6 thus form a modular structural unit.

A transformer housing 8 is arranged on the rotor housing 13 in the axial direction and is connected to the rotor housing 13 in a rotationally fixed manner. A secondary winding 2 is arranged on an inner lateral surface of the transformer housing. The secondary coil 2 comprises a ferrite core 11 and a winding 12. The secondary winding 2 is arranged coaxially to the primary winding 1 and overlaps with it in the axial direction. The transformer housing 8 has an axial surface facing away from the rotor, on which rectifier electronics 4 are arranged. The secondary winding is connected via the rectifier electronics 4 to the windings of the rotor in an electrically conductive manner (not shown in this view). In the embodiment shown, the secondary coil 2 and the rectifier electronics 4 are encapsulated with an epoxy compound to protect against environmental influences and to improve the thermal coupling and electrical insulation of the components. The secondary coil 2, the rectifier electronics 4, and the transformer housing 8 thus form a modular structural unit.

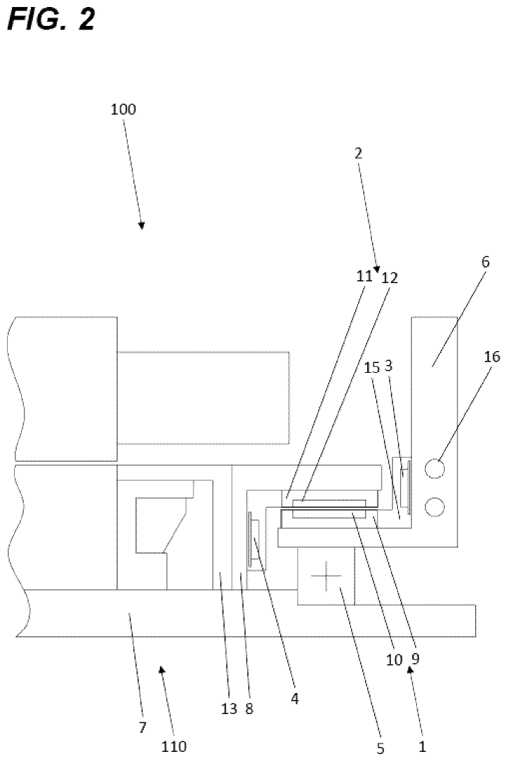

FIG. 2 shows an electric machine with a contactless energy transmission device in a schematic axial sectional view in a second embodiment. The second embodiment only differs from the first embodiment of FIG. 1 by channels 16 in the second cylinder ring section of the housing part 6. The channels are designed to carry a cooling liquid and are connected to a cooling system (not shown). The cooling channels run in sections in radial and tangential directions within the housing part 6 and thus form a meandering structure. The channels 16 are arranged in a radial direction in the area of the inverter electronics 3 in order to achieve the best possible heat dissipation. The channels 16 are designed as closed lines in the housing part 6, so the cooling liquid is not in direct contact with the inverter electronics 3.

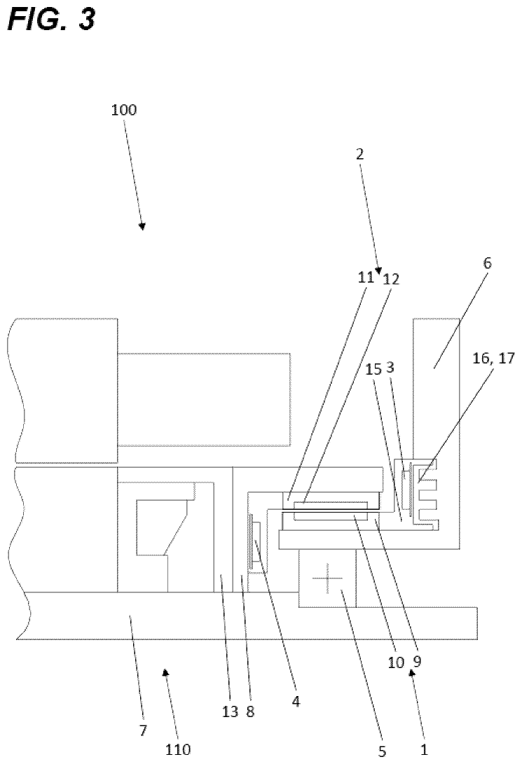

FIG. 3 shows an electric machine with a contactless energy transmission device in a schematic axial sectional view in a third embodiment. The third embodiment allows direct cooling or heat dissipation of the inverter electronics 3. In the second cylinder ring section, a groove 17 is formed in the first axial surface, which is closed by the inverter electronics 3 and thus forms a channel 16 for guiding a cooling liquid. Ribs (18) are formed in the groove to increase the cooling surface. This results in better heat dissipation. Although the second and third embodiments are shown as alternatives, a combination of the closed channels of the second embodiment with the channel of the third embodiment is possible.

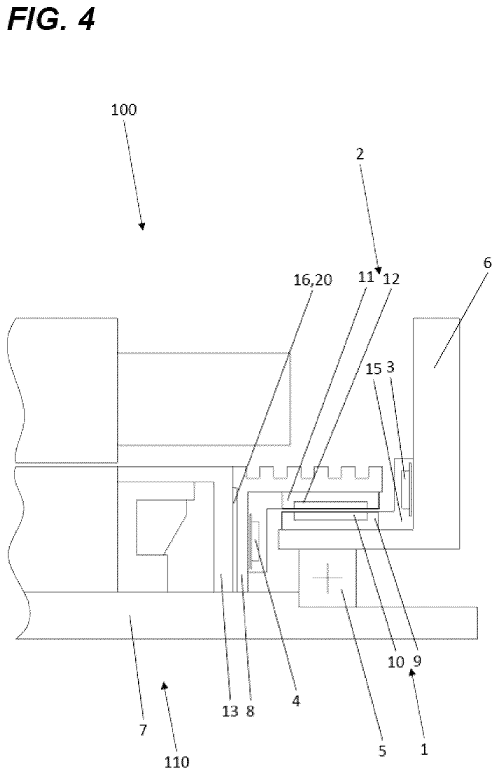

FIG. 4 shows an electric machine with a contactless energy transmission device in a schematic axial sectional view in a fourth embodiment. The fourth embodiment differs from the first embodiment in the following elements. The fourth embodiment can be combined with both the second embodiment and the third embodiment. In the fourth embodiment, a radial outer surface of the transformer housing 8 has ribs 17 which run substantially tangentially. This results in improved speed stability as well as improved convective heat dissipation due to the increased surface area of the radial outer surface.

Furthermore, a cavity 20 is arranged between the rotor housing and the transformer housing, which forms a channel 16 for guiding a cooling medium and is connected to a cooling system (not shown). This improves heat dissipation, particularly in the area of the rectifier electronics 4 and the secondary coil 2.

The disclosure is not limited to the embodiments shown in the figures. The above description is therefore not to be regarded as limiting, but rather as illustrative. The following claims are to be understood as meaning that a stated feature is present in at least one embodiment of the disclosure. This does not exclude the presence of further features. Where the claims and the above description define “first” and “second” features, this designation serves to distinguish between two features of the same type without defining an order of precedence.

### LIST OF REFERENCE SYMBOLS

1. Primary coil
2. Secondary coil
3. Inverter electronics
4. Rectifier electronics on
5. Roller bearing/rotor bearing
6. Housing part/bearing plate
7. Rotor shaft
8. Transformer housing
9. Ferrite core of the primary coil
10. Winding of the primary coil
11. Ferrite core of the secondary coil
12. Winding of the secondary coil
13. Rotor housing
14. Casting or plastic overmolding
15. Casting or plastic overmolding
16. Cooling channel
17. Groove
18. Ribs
20. Cavity
100 Electric machine
110. Rotor

1. A contactless energy transmission device for a rotor of an electric machine comprising
a housing part coupled in a rotationally rigid manner to a housing of the electric machine;
an inductive transformer including a primary coil that is configured to be energized and a secondary coil that is arranged at a distance from the primary coil and is coupled to a winding of the rotor in an electrically conductive manner; and
a roller bearing, by means of which a rotor shaft is rotatably mounted relative to the housing part,
wherein:
the primary coil of the inductive transformer is positioned relative to the housing part in a rotationally rigid manner with respect thereto, and
the roller bearing is arranged within the housing part such that the primary coil and the roller bearing are arranged coaxially, and
the secondary coil of the inductive transformer is arranged within a transformer housing, wherein the transformer housing is connected to the rotor in a rotationally fixed manner.

2. The contactless energy transmission device according to claim 1, wherein the primary winding and the secondary winding of the inductive transformer are arranged coaxially to one another within the transformer housing.

3. The contactless energy transmission device according to claim 1, wherein the roller bearing has an inner ring and an outer ring, between which a plurality of rolling elements are accommodated, wherein the inner ring is connected to the rotor shaft in a rotationally fixed manner and the outer ring is connected to the housing part in a rotationally fixed manner.

4. The contactless energy transmission device according to claim 3, wherein the housing part has a first cylinder ring section, on the outer lateral surface of which the primary coil is arranged, and on the inner lateral surface of which the outer ring of the roller bearing is arranged in such a way that the roller bearing and the primary coil overlap at least in sections.

5. The contactless energy transmission device according to claim 4, wherein the housing part has a second cylinder ring section which extends radially outward from the outer lateral surface of the first cylinder ring section, wherein inverter electronics are arranged on a first axial surface of the second cylinder ring section which faces the rotor.

6. The contactless energy transmission device according to claim 1, wherein the housing part is a bearing plate of the electric machine.

7. The contactless energy transmission device according to claim 1, wherein the housing part has a channel for guiding a cooling liquid.

8. The contactless energy transmission device according to claim 7, wherein the channel in the second cylinder ring section is formed by a groove in the first axial surface and by the inverter electronics covering the groove.

9. The contactless energy transmission device according to claim 5, wherein the primary coil, the inverter electronics and the housing part form a modular structural unit.

10. The contactless energy transmission device according to claim 1, wherein the secondary coil, rectifier electronics and the transformer housing form a modular structural unit.

11. A contactless energy transmission device for a rotor of an externally excited synchronous machine within a powertrain of a motor vehicle comprising:
a housing part coupled in a rotationally rigid manner to a housing of the electric machine;
an inductive transformer including a primary coil that is configured to be energized and a secondary coil that is arranged at a distance from the primary coil and is coupled to a winding of the rotor in an electrically conductive manner; and
a roller bearing configured to rotatably mount a rotor shaft to the house part,
wherein:
the primary coil of the inductive transformer is positioned relative to the housing part in a rotationally rigid manner with respect thereto, and
the roller bearing is arranged within the housing part such that the primary coil and the roller bearing are arranged coaxially,
the secondary coil of the inductive transformer is arranged within a transformer housing, wherein the transformer housing is connected to the rotor in a rotationally fixed manner, and
the primary winding and the secondary winding of the inductive transformer are arranged coaxially to one another within the transformer housing.

12. The contactless energy transmission device according to claim 11, wherein the roller bearing has an inner ring and an outer ring, between which a plurality of rolling elements are accommodated, wherein the inner ring is connected to the rotor shaft in a rotationally fixed manner and the outer ring is connected to the housing part in a rotationally fixed manner.

13. The contactless energy transmission device according to claim 12, wherein the housing part has a first cylinder ring section, on the outer lateral surface of which the primary coil is arranged, and on the inner lateral surface of which the outer ring of the roller bearing is arranged in such a way that the roller bearing and the primary coil overlap at least in sections.

14. The contactless energy transmission device according to claim 13, wherein the housing part has a second cylinder ring section which extends radially outward from the outer lateral surface of the first cylinder ring section, wherein inverter electronics are arranged on a first axial surface of the second cylinder ring section which faces the rotor.

15. The contactless energy transmission device according to claim 11, wherein the housing part is a bearing plate of the electric machine.

16. The contactless energy transmission device according to claim 11, wherein the housing part has a channel for guiding a cooling liquid.

17. The contactless energy transmission device according to claim 16, wherein the channel in the second cylinder ring section is formed by a groove in the first axial surface and by the inverter electronics covering the groove.

18. The contactless energy transmission device according to claim 14, wherein the primary coil, the inverter electronics and the housing part form a modular structural unit.

19. The contactless energy transmission device according to claim 11, wherein the secondary coil, rectifier electronics and the transformer housing form a modular structural unit.

20. An electric machine comprising:
a contactless energy transmission device comprising
a housing part coupled in a rotationally rigid manner to a housing of the electric machine;
an inductive transformer including a primary coil that is configured to be energized and a secondary coil that is arranged at a distance from the primary coil and is coupled to a winding of the rotor in an electrically conductive manner; and
a roller bearing configured to rotatably mount a rotor shaft to the house part,
wherein:
the primary coil of the inductive transformer is positioned relative to the housing part in a rotationally rigid manner with respect to the housing part,
the roller bearing is arranged within the housing part such that the primary coil and the roller bearing are arranged coaxially, and
the secondary coil of the inductive transformer is arranged within a transformer housing, wherein the transformer housing is connected to the rotor in a rotationally fixed manner.
